(19) United States
(12) Patent Application Publication
(10) Pub. No.: US 2016/0221833 A1
(43) Pub. Date: Aug. 4, 2016

(54) Method and System for Preparing High Purity Lithium Carbonate

(71) Applicants: Binyuan ZHU, Guangdong (CN); TIBET JINRUI ASSET MANAGEMENT CO., LTD.), Tibet (CN); GUANGZHOU RUISHITIANQI ENERGY TECHNOLOGY CO., LTD., Guangdong (CN); DONGGUAN FOREST ENVIRONMENTAL PROTECTION EQUIPMENT CO., LTD., Dongguan, guangdong (CN)

(72) Inventors: Binyuan ZHU, Guangzhou City (CN); Hao YU, Guangzhou City (CN); Rui ZHU, Guangzhou City (CN); Fuming PENG, Dongguan City (CN); Tailin WU, Dongguan City (CN)

(73) Assignees: Binyuan ZHU, Guangzhou City (CN); Tibet Jinrui Asset Management Co., Ltd., Lhasa, Tibet (CN); Guangzhou Ruishi Tianqi Energy Technology Co., Ltd, Guangzhou City (CN)

(21) Appl. No.: 15/021,385

(22) PCT Filed: Sep. 12, 2014
(86) PCT No.: PCT/CN2014/086344

§ 371 Date: Mar. 11, 2016

(30) Foreign Application Priority Data
Sep. 13, 2013 (CN) 201310417287.3
Nov. 29, 2013 (CN) 201310619547.5
Jan. 28, 2014 (CN) 201420055996.1
May 26, 2014 (CN) 201420272850.2

(51) Int. Cl. C01D 15/08; B01D 9/00; C22B 3/04; C22B 3/02; C22B 26/12; C22B 3/44

(52) U.S. Cl. CPC C01D 15/08; C22B 26/12; C22B 3/44; C22B 3/04; C22B 3/02; B01D 9/00

(57) ABSTRACT

The invention discloses a preparation method and system of high purity lithium carbonate. The preparation method comprises: concentrating carbonic acid type salt lake bittern, then heating up to saturate, crystallize and separate out the lithium carbonate, and collecting crystals to obtain refined salts of lithium carbonate; flushing the collected refined salts of lithium carbonate with distilled water with a temperature above 60° C. to dissolve sodium-potassium salts therein; drying to obtain the high purity lithium carbonate. For the lithium carbonate purification process, chemical reagents are not needed, the refining and purification of the lithium carbonate may be finished by physical operation, the purification of the refined and purified lithium carbonate is up to above 95%, which is beneficial for reducing the transportation cost at the later stage and the further purified cost. The process has an extremely low requirement for transportation and does not contaminate the environment at the same time.

### TECHNICAL FIELD

The invention relates to a purification process and system of lithium carbonate.

### BACKGROUND

Lithium has strong electrochemical activity and also is a light metal, so it is widely used. Currently, the application field of lithium includes: ceramics and glass, synthetic rubber, the production of aluminum, plastics, pharmaceuticals, lubricants, air conditioner, TV (fluorescent screen), lithium batteries, lithium alloys and nuclear industries, etc. The consumption quantity amounts to tens of thousands of tons per year and still keeps growing.

In the total amount of lithium resources in the world, bittern lithium ore accounts for about 75%, and hard rock lithium ore accounts for about 25%. In the total amount of lithium resources in China, bittern lithium ore accounts for about 72%, and hard rock lithium ore accounts for about 28%. Before the 1960s, the lithium resources were mainly from the hard rock lithium ore. The cost for extracting lithium from the salt lake is 1-1.5 times lower than the hard rock. Currently the lithium salts produced from the salt lake have exceeded the hard rock lithium ore, and extracting the lithium salts from the salt lake bittern has become the development trend.

Since the hydrochemical type of the lithium-contained salt lake and the economic technology condition are different, the process routes adopted also differ from one another. Methods for extracting lithium from bittern in the prior art include: organic ions (TBP, i.e., tributyl phosphate, etc.) exchange resin method, inorganic ion exchanger method, aluminate method, hydrogen chloride salting method, aluminate method and precipitation method (i.e. phosphate method) and carbon method, etc. But these methods all have problems of higher energy consumption, more material consumption, difficulty in selection of some systems, low capacity or complicated technological process, and environment contamination, etc.

In addition, a salt field method is adopted in the Atacama Lake in Chile, the Silver Peak Lake in the United States and other sulfate salt lakes to perform pre-concentration, and then the products obtained are transported to a plant for machining. However, as China's major salt lakes are carbonate salt lakes, the salt field method applicable to the sulfate salt lake is not applicable to the China's major salt lakes. At the end of the previous century, our experts have proposed a salt field method applicable to the carbonate salt lakes, which has been actually applied in the extraction of the lithium salts. However, it is discovered after the practice that the technology has the following disadvantages, resulting in losses:

1. a large area of salt field needs to be built, and the construction cost and the ongoing maintenance costs are extremely high; at the same time, the evaporation of the salt lakes are greatly increased in a manual manner, so the liquid level balance of the salt lakes is damaged, which may affect the ecology of the salt lake areas;

2. it is greatly affected by natural conditions;

3. low purity of the lithium salts with more impurities after preparation, and the lithium salts need to be transported to the plant for further processing; in this way, the transportation cost is very high; and most of which is “useless transportation” for transporting the impurities; and

4. the salt preparation time is long; automation may not be achieved during the technological process, so the efficiency is low.

In addition, the existing salt lakes are basically located in the remote areas, the traffic is inconvenient, and energy sources and the fresh water are insufficient, which further increases the difficulty in purification.

Therefore, an improved method and a system for extracting lithium salts from carbonate salt lakes is needed.

### SUMMARY

An object of the invention is to provide a preparation method and a preparation system of lithium carbonate.

The invention adopts the technical solution as follows.

1) concentrating carbonic acid type salt lake bittern, then heating up to saturate, crystallize and separate out the lithium carbonate, and collecting crystals to obtain refined salts of lithium carbonate;

2) flushing the collected refined salts of lithium carbonate with distilled water that is recycled by evaporating and concentrating the above bittern with a temperature above 60° C. to dissolve sodium-potassium salts therein; and

3) drying to obtain the high purity lithium carbonate.

Preferably, the salt lake bittern is concentrated by decompressing evaporation, then heated up to above 60° C., preferably above 65° C. or 70° C., and kept warm to crystallize and separate out the lithium carbonate.

The refined salts of lithium carbonate are flushed by using the distilled water that is recycled when evaporating and concentrating the bittern until the quantity basically remains unchanged. Generally speaking, when the refined salts of lithium carbonate are flushed until the mass is reduced to 20-30% of the original mass (dry weight), the mass is basically stable and does not obviously reduce in spite of continuous flush for 1-2 hours. In this case, the significance of continuous flush may not remarkably improve the purity of the high purity lithium carbonate, so the flush may be stopped to save water and other energy sources and improve the production efficiency at the same time.

As a further improvement of the invention, the flushing direction is switched in a timing manner when flushing. The flushing direction is changed every 10 s or 20 s, which is more beneficial for improving the flushing efficiency and preventing blocking the filter screen by the crystals.

As a further improvement of the invention, the high purity lithium carbonate is prepared by the distilled water that is recycled when evaporating and concentrating the bittern, and the distilled water is condensate water obtained by evaporating and concentrating the bittern.

There is provided a preparation system for preparation of high purity lithium carbonate. The system includes a bittern concentration crystallizer and a refiner. The bittern concentration crystallizer is provided with a heat accumulation pot and a heating pot. Both the heat accumulation pot and the heating pot are independently provided with a heat exchanging device. The heat exchanging device of the heat accumulation pot and the heating pot is connected with a heat absorption end and a heat releasing end of the heat pump respectively. The heating pot is provided with a bittern inlet and a tail bittern outlet. The tail bittern outlet is connected to the heat accumulation pot via the pipeline. The refiner includes a refining and purifying pot. The refining and purifying pot is provided with a water outlet and a water inlet, and the lower portion in the refining and purifying pot is provided with a radial filter screen for supporting lithium carbonate crystals. The upper portion in the refining and purifying pot is provided with a detachable radial screen for preventing the lithium carbonate crystals from flowing out.

As a further improvement of the invention, the bittern concentration crystallizer is connected with a vacuum device which is connected with a water vapor condenser, and the water vapor condenser is connected with a distilled water temporary storage tank. The vacuum device may extract the water vapor to reduce the pressure at the liquid surface, which is beneficial for accelerating the concentration of the liquid. The extracted water vapor is condensed to produce distilled water in a subsidiary manner, which is particularly applicable to remote areas that lack purified water.

As a further improvement of the invention, a temporary storage tank for the distilled water that is recycled when evaporating and concentrating the bittern is connected to the water inlet of the refining and purifying pot.

As a further improvement of the invention, a filter screen is arranged at the front of the tail bittern outlet.

As a further improvement of the invention, a circulating pump is arranged between the water outlet and the water inlet of the refining and purifying pot.

As a further improvement of the invention, the refiner is provided with a heat exchanging device.

As a further improvement of the invention, a detachable inner filter screen layer is arranged in the heating pot.

As a further improvement of the invention, the refining and purifying pot is provided with a hot blown air drying device. The hot blown air drying device may be simply arranged in a hot blown air inlet and outlet of the refining and purifying pot.

As a further improvement of the invention, the water outlet of the refining and purifying pot is provided with a three-way valve, and one end of the three-way valve is connected to the heat accumulation tank via the pipeline.

As a further improvement of the invention, a filter screen is arranged at the front of the water outlet and the water inlet of the refining and purifying pot.

The invention has the following beneficial effects:

For the lithium carbonate purification process according to the invention, chemical reagents are not needed, the refining and purification of the lithium carbonate may be finished by physical operation, the purification of the refined and purified lithium carbonate is up to above 95%, which is beneficial for reducing the transportation cost at the later stage and the further purified cost. The process according to the invention has an extremely low requirement for transportation and does not contaminate the environment at the same time.

The lithium carbonate purification process according to the invention may fully recycle the water vapor produced by evaporating and concentrating the salt lake bittern and the water vapor is condensed into the purified distilled water. After use, the distilled water may be returned to the salt lakes again to effectively compensate water for the salt lakes, which avoids an ecological problem caused by the fall of the water level of the salt lakes.

By utilizing the vacuum device, the concentration of the bittern is accelerated and the distilled water may be produced by the condensed water vapor in a subsidiary manner as well. The distilled water obtained may be further used for the purification of the refined salts of lithium carbonate. The problem of lack of fresh water (distilled water) in the remote salt lake areas is effectively solved, so as to further reduce the purification cost. After use, the distilled water may drain into the salt lakes again to effectively compensate water for the salt lakes, which avoids or reduces an ecological problem caused by the fall of the water level of the salt lakes.

The lithium carbonate purification system according to the invention is convenient to use and may prepare and obtain high purity lithium carbonate. At the same time, sodium and potassium salts may be produced in the heat accumulation pot in a subsidiary manner.

For the lithium carbonate purification system according to the invention, chemical agents are not required to additionally compensate, so that the energy utilization rate is high.

### BRIEF DESCRIPTION OF THE DRAWINGS

FIG. 1 is a structural diagram of a concentration crystallizer of a preparation system according to the invention; and

FIG. 2 is a structural diagram of a refiner of a preparation system according to the invention.

### DETAILED DESCRIPTION OF THE PREFERRED EMBODIMENTS

A preparation method of high purity lithium carbonate includes the steps as follows:

1) carbonic acid type salt lake bittern is concentrated, then heated up to saturate, crystallize and separate out the lithium carbonate, and crystals are collected to obtain refined salts of lithium carbonate;

2) the collected refined salts of lithium carbonate are flushed with distilled water that is recycled by evaporating and concentrating the above bittern at a temperature above 60° C. to dissolve sodium-potassium salts therein; and

3) the high purity lithium carbonate is obtained after drying.

Preferably, the salt lake bittern is concentrated by decompressing evaporation, and then is heated up to above 60° C., and kept warm at a temperature of above 65° C. and 70° C. to crystallize and separate out the lithium carbonate. The higher the temperature is during the course of crystallization, the more beneficial it is for separating out the refined salts of lithium carbonate with higher purity, which is beneficial for reducing the difficulty in the subsequent purification operation.

The distilled water is used for flushing the refined salts of lithium carbonate until the mass is not obviously reduced. Generally speaking, when the refined salts of lithium carbonate are flushed until the mass is reduced to 20-30% of the original mass (dry weight), the mass is basically stable and does not obviously reduce in spite of continuous flushing for 1-2 hours. In this case, the significance of continuous flush may not remarkably improve the purity of the high purity lithium carbonate, so the flush may be stopped to save water and other energy sources and improve the production efficiency at the same time.

As a further improvement of the invention, the flushing direction is switched in a timing manner when flushing the collected refined salts of lithium carbonate. The flushing direction is changed every 10 s or 20 s, which is more beneficial for improving the flushing efficiency and preventing the blockage of the filter screen by the crystals.

The distilled water is the condensate water obtained from concentrating or evaporating the bittern.

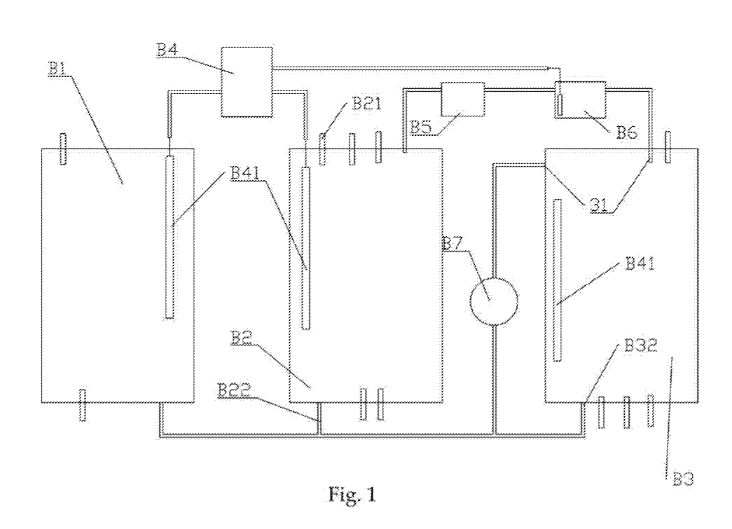

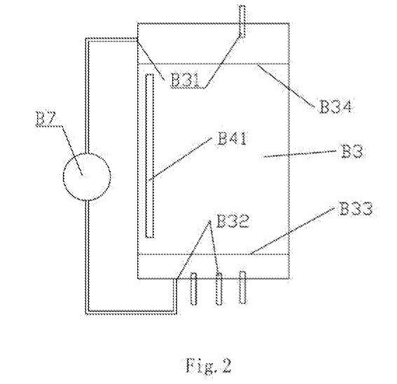

As shown in FIG. 1 and FIG. 2, a preparation system of high purity lithium carbonate includes a bittern concentration crystallizer and refiner. The bittern concentration crystallizer is provided with a heat accumulation pot B1 and a heating pot B2. Both the heat accumulation pot B1 and the heating pot B2 are independently provided with a heat exchanging device B41. The heat exchanging device of the heat accumulation pot B1 and the heating pot B2 is connected with a heat absorption end and a heat releasing end of the heat pump B4 respectively, wherein the heating pot B2 is provided with a bittern inlet B21 and a tail bittern outlet B22. The tail bittern outlet B22 is connected to the heat accumulation pot B1 via the pipeline. The refiner includes a refining and purifying pot B3, which is provided with a water outlet B32 and a water inlet B31. The lower portion in the refining and purifying pot B3 is provided with a radial filter screen B33 for supporting lithium carbonate crystals. The inner upper portion in the refining and purifying pot B3 is provided with a detachable radial screen B34 for preventing the lithium carbonate crystals from flowing out.

As a further improvement of the invention, the bittern concentration crystallizer is connected with a vacuum device B5, which is connected with a water vapor condenser. The water vapor condenser is connected with a distilled water temporary storage tank B6. The vacuum device may vacuums the water vapor to reduce the pressure at the liquid surface, which is beneficial for accelerating the concentration of the liquid. The extracted water vapor is condensed to produce distilled water in a subsidiary manner, which is particularly applicable to remote lake areas of purified water.

As a further improvement of the invention, the distilled water temporary storage pot B6 is provided with a water inlet B31 connecting to the refining and purifying pot. Of course, in order to improve the refined and purified efficiency, the distilled water may be preheated to the temperature as required before guiding it into the refining and purifying pot. Furthermore, the refiner is provided with a heat exchanger B41, so as to ensure the temperature in the pot is kept stable during the course of flush. The heat exchanger B41 may not only be arranged in the refining and purifying pot, but also may be arranged in the outside pipeline or the circulating pump, preferably, may be arranged in the distilled water temporary storage pot, or arranged in a plurality of positions at the same time, so as to ensure the temperature of the distilled water is kept at the temperature required during the course of flush.

As a further improvement of the invention, a filter screen is arranged at the front of the tail bittern outlet, which may avoid bringing out the crystallized refined salts of lithium carbonate during the course of discharging the tail bittern to affect the yield.

As a further improvement of the invention, a detachable inner filter screen layer is arranged in the heating pot. This may ensure the vast majority of lithium carbonate crystals are caught in the filter screen, which may be convenient to remove the lithium carbonate obtained. The removed lithium carbonate may be transferred to the refining and purifying pot for further purification.

As a further improvement of the invention, a circulating pump B7 is arranged between the water outlet B32 and the water inlet B31 of the refining and purifying pot. This may circulate the hot water to flush the crystallized refined salts of lithium carbonate to accelerate the purification process. The water discharged from the circulating pump preferably flushes the crystallized refined salts of lithium carbonate from the bottom upward. In this way, the crystals are prevented from settling to the bottom which makes them difficult to flush, which could affect the purification effect. Of course, the other flushing modes may also be adopted, for example, flushing from up to down, flushing in a rotating manner, or combining several flushing modes.

As a further improvement of the invention, the refining and purifying pot is provided with a hot blown air drying device. The hot blown air drying device may be simply arranged in a hot blown air inlet and outlet of the refining and purifying pot. The hot air is preferably blown in from the bottom of the lithium carbonate crystals and blown out from the upper portion, which may more rapidly dry the purified lithium carbonate.

As a further improvement of the invention, the water outlet of the refining and purifying pot is provided with a three-way valve, with one end of the three-way valve connected to the heat accumulation tank via the pipeline. The three-way valve may conveniently control the flow direction of the water according to the needs. The hot water after finishing flushing is guided into the heat accumulation pot, where the waste heat is utilized by the heat pump, which is beneficial to improve the use ratio of the energy source, which is more particularly applicable to the remote areas.

As a further improvement of the invention, a filter screen is arranged at the front of the water outlet and the water inlet of the refining and purifying pot. This is beneficial for preventing the crystals from flowing into the pipeline to affect the normal operation of the device and the yield of the lithium carbonate.

### Embodiment 1

Bittern with a Li ionic concentration of 1.29 g/L is evaporated at a temperature above 60° C. to crystallize and separate out coarse lithium salts and bittern mixed wet salt, the weight of which is 897.6 g after simply removing a supernatant. Then the yield is mixed with 3000 g distilled water at 80° C. at one time and sufficiently stirred for 3 minutes to obtain 47.4 g lithium carbonate with a purity of 62% after the mixture is subjected to suction filtration and drying, and the yield of lithium carbonate obtained from the coarse lithium salt is 73.5%.

### Embodiment 2

Bittern with a Li ionic concentration of 1.29 g/L is evaporated at a temperature above 60° C. to crystallize and separate out coarse lithium salt and bittern mixed wet salt, the weight of which is 877.9 g after simply removing a supernatant. The yield is flushed with a total amount of 2250 g distilled water at 70° C. for 4 times (1200 g, 600 g, 300 g and 150 g respectively) in a manner of the embodiment 1 and sufficiently stirred for 30 seconds every time (the total time for stirring is 2 minutes) to obtain 37.56 g lithium carbonate with a purity of 91.3% is obtained after the mixture is subjected to suction filtration and drying, and the yield of lithium carbonate obtained from the coarse lithium salt is 85.7%.

### Embodiment 3

Bittern with a Li ionic concentration of 1.29 g/L is evaporated at a temperature above 60° C. to crystallize and separate out coarse lithium salt and bittern mixed wet salt, the weight of which is 986.7 g after simply removing a supernatant. The yield is placed into a refined and purified tank, and added with 1800 g distilled water with a temperature of 90° C., which is recycled for 1 minute with the direction being changed once in every 10 seconds to obtain 39.74 g dried lithium carbonate with a purity of 97.6% after the mixture is dried by hot blown air, and the yield of lithium carbonate obtained from the coarse lithium salts is 96.97%.

It may be known from the data of the above-mentioned embodiments that the refining and purifying pot may rapidly, continuously perform the purification link of the refined salts of lithium carbonate by saving water. The direction is changed for flushing, which may not only improve the flushing efficiency, but also avoids accumulation of crystals in the pipeline or the refined and purified tank, so that the self-cleaning may be achieved, the device is convenient to use, and the maintenance is reduced.

The purification operation time for the coarse salts of lithium carbonate is reduced to ⅓ of the traditional method in the link. The self-cleaning design avoids the malpractice that the traditional scrubbing mode must be frequently maintained. The quantity of the distilled water for flushing is reduced to 60% of the traditional method, and the systemic loss of the lithium carbonate in the traditional process is avoided, so that the lithium carbonate product with good purity is obtained, the grade of which is more than 97% and the yield is more than 96%.

1-41. (canceled)

42. A preparation method of high purity lithium carbonate, comprising:
(a) concentrating carbonic acid type salt lake bittern, then heating up to saturate, crystallize and separate out the lithium carbonate, and collecting crystals to obtain refined salts of lithium carbonate;
(b) flushing the collected refined salts of lithium carbonate with distilled water with a temperature above 60° C. to dissolve sodium-potassium salts therein; and
(c) drying to obtain the high purity lithium carbonate.

43. The preparation method according to claim 42, wherein the distilled water is condensate water that is recycled by evaporating and concentrating the bittern.

44. The preparation method according to claim 42, wherein the flushing is stopped when the mass of the refined salts of lithium carbonate flushed by the distilled water is not reduced obviously.

45. The preparation method according to claim 42, wherein the flushing direction is switched in a timing manner when flushing.

46. The preparation method according to claim 43, wherein the flushing direction is switched in a timing manner when flushing.

47. A preparation system for preparation of high purity lithium carbonate, wherein the system comprises a bittern concentration crystallizer and refiner, the bittern concentration crystallizer is provided with a heat accumulation pot and a heating pot, both the heat accumulation pot and the heating pot are independently provided with a heat exchanging device, the heat exchanging devices of the heat accumulation pot and the heating pot are connected with a heat absorption end and a heat releasing end of the heat pump respectively, the heating pot is provided with a bittern inlet and a tail bittern outlet, the tail bittern outlet is connected to the heat accumulation pot via the pipeline; the refiner comprises a refining and purifying pot, the refining and purifying pot is provided with a water outlet and a water inlet, and the lower portion in the refining and purifying pot is provided with a radial filter screen for supporting lithium carbonate crystals, wherein the upper portion in the refining and purifying pot is provided with a detachable radial screen for preventing the lithium carbonate crystals from flowing out.

48. The preparation system according to claim 47, wherein the bittern concentration crystallizer is connected with a vacuum device which is connected with a water vapor condenser, and the water vapor condenser is connected with a distilled water temporary storage tank.

49. The preparation system according to claim 47, wherein a circulating pump is arranged between the water outlet and the water inlet of the refining and purifying pot.

50. The preparation system according to claim 47, wherein the refiner is provided with a heat exchanging device.

51. The preparation system according to claim 47, wherein the refiner is provided with a hot blown air drying device.

52. The preparation system according to claim 48, wherein the refiner is provided with a hot blown air drying device.

53. The preparation system according to claim 51, wherein the water outlet of the refining and purifying pot is provided with a three-way valve, and one end of the three-way valve is connected to the heat accumulation tank via the pipeline.
